(19) United States
(12) Patent Application Publication
(10) Pub. No.: US 2007/0008133 A1
(43) Pub. Date: Jan. 11, 2007

(54) System and method for managing entrance and exit of employees by utilizing a keytag

(75) Inventor: Pil Kyung Kang, Seoul (KR)

Correspondence Address: GWIPS;PETER T. KWON, P.O. BOX 231630, CENTERVILLE, VA, 20120, US

(73) Assignee: IDTECK CO., LTD.

(21) Appl. No.: 11/183,483

(22) Filed: Jul. 18, 2005

(30) Foreign Application Priority Data
Jul. 6, 2005 (KR) 10-2005-0060683

(51) Int. Cl. G08B 13/14

(52) U.S. Cl. 340/572.1

(57) ABSTRACT

A system and a method for managing the entrance and exit of employees by utilizing a keytag comprises a keytag (100) for emitting a unique frequency containing personal data along with a flashing light signal when the keytag bearer arrives or brings it into contact with an entrance terminal scanner, a data reader (200) for receiving the personal data emitted by the keytag (100), a controlling server (300) for comparing the received unique personal data with pre-stored personal data to determine an access permission. The keytag (100) consists of a memory unit (130) for storing the personal data, an antenna unit (110) for communicating the personal data signal remotely or through contact, a power source (120) for activating the keytag (100), a signal light unit (150) for emitting the visible signal, and a control unit (140) for controlling each unit.

### BACKGROUND OF THE INVENTION

1. Field of the Invention

The present invention relates to a system and a method for managing the entrance and exit of employees by utilizing a keytag with a flashing light signal. More particularly, the keytag emits a unique frequency containing the personal ID data along with a visible light signal, a data reader receives the emitted signal to verify the identity of the employee through a control server when a bearer approaches a check point, and the keytag communicates with the control server via the antenna unit.

2. Related Prior Art

Radio frequency identification (RFID) technology combining the application of the electromagnetic spectra in the wireless frequencies and the static electricity coupling has been developed for recognizing the contents of objects, tracking animal movements or managing personnel without direct contact or scanning on a reader. Due to the advantages, the prevalence of RFID is increasingly replacing bar code reader technology.

Such an RFID system consists of three components: antenna, transceiver and transponder, also called a tag. The antenna transmits a signal to activate the transponder by using a wireless frequency. As the transponder is activated, the transponder transmits the stored data to the antenna for verification. Through the mutual communication process, it is possible to verify the identification. Therefore, the technology can be applied to various practices, such as an entrance control system or vending machines.

The RFID system adopts two kinds of frequencies. A low frequency RFID of 30 KHz˜500 KHz is used for short range transmission within 1.8 meters. A high frequency RFID of 850 KHz˜950 KHz and 2.4 GHz˜2.5 GHz is used for long range transmissions.

Generally, the conventional entrance management system is operated with an on-duty security guard all the time to protect against bearers of counterfeit ID.

To operate the entrance management system without a security guard, it is necessary to provide a means of verifying employment even if the employee's ID data are pre-stored in the personnel management control system. Along with the pre-stored personal ID data, an automatic door operating and controlling system is also required. The door controlling system is a separate unit from the employee entrance management system. However the door controlling system is actuated according to the activation signal from the entrance management system.

Most conventional entrance management systems use a scanning method to read the personal ID data. The direct-scanning read-in data system is very inconvenient, especially in the late evening. Sometimes, a user has to scan more than once due to misreading of the personal ID data.

If the personal ID data is automatically read in from a remote distance without scanning when the user approaches the entrance, it will be a merit especially when it is dark. Further, it is possible for the user to be sure that the personal ID data has been correctly read when they see the flashing lights.

### SUMMARY OF THE INVENTION

To overcome the aforementioned disadvantages, a system and a method for managing the entrance and exit of the employees by utilizing a keytag with visible flashing light of the present invention is provided.

An objective of the present invention is to provide a system comprising a keytag for emitting a unique frequency containing personal ID data, as well as a visible flashing light when a bearer arrives or brings the keytag into contact with an entrance terminal scanner to pass the check point, a data reader for receiving the unique personal ID data emitted by the keytag, a controlling server for comparing the received unique personal ID data with a pre-stored personal ID database to determine access permission.

Another objective of the present invention is to provide the keytag comprising a memory unit for storing the personal ID data, an antenna unit for communicating the personal ID data signal remotely or on contact, a power source for activating the keytag, a signal light unit for emitting the personal ID data signal, and a control unit for controlling each component of the inter-connected units.

Still another objective of the present invention is to provide a method for managing entrance and exit of employees through a gate by utilizing an electronic device, the method comprising the steps of: receiving a signal of personal ID data emitted by a keytag when a key bearer arrives or brings it into contact on an entrance terminal scanner to pass the check point, checking whether the frequency of the received signal emitted by the keytag matches that of the entrance terminal scanner, searching whether the received personal ID data is in the pre-stored personal ID database of a controlling server, identifying the key bearer with the received personal ID data, if the received personal ID data is found in the pre-stored personal ID data base, permitting the bearer to pass through the check point, if the bearer is identified with the received personal ID data, and recording the checked time and the personal ID data.

### BRIEF DESCRIPTION OF THE DRAWINGS

FIG. 1 is an overall block diagram for managing the entrance and exit of the employees by utilizing a keytag according to the present invention.

FIG. 2 is an internal configuration of the keytag for managing the entrance and exit of the employees according to the present invention.

FIG. 3 is an internal configuration of the controlling server for managing-the entrance and exit of the employees according to the present invention.

FIG. 4 is a circuit diagram of the keytag for-emitting the signal light according to the present invention.

FIG. 5a shows an internal front view of the keytag for emitting the signal light according to the present invention.

FIG. 5b shows an internal rear view of the keytag for emitting the signal light according to the present invention.

FIG. 6 shows a schematic drawing of a keytag for managing the entrance and exit of employees according to the present invention.

FIG. 7 is a flow chart for managing the entrance and exit of employees by utilizing an electronic keytag according to the present invention.

### DETAILED DESCRIPTION OF THE PREFERRED EMBODIMENT

In order to accomplish the aforementioned objectives, a system and a method for managing the entrance and exit of employees through a gate by utilizing a keytag of the present invention has been developed. The system is comprised of a keytag for emitting a unique frequency containing personal ID data along with a flashing light signal when a bearer arrives or brings it into contact with an entrance terminal scanner, a data reader for receiving the personal ID data emitted by the keytag, and a server for comparing the received unique personal ID data with the pre-stored personal ID data to determine access permission.

Hereinafter, the preferred embodiment of the present invention is described in detail with reference to the accompanying drawings.

When a keytag bearer arrives or brings the keytag into contact with an entrance terminal, a data reader at the entrance receives the unique frequency containing the personal ID data emitted by the keytag. Then, a data reader transmits the received personal ID data to a controlling server for comparing with the pre-stored personal ID in the data base. After completing the search, the controlling server determines an access permission and transmits a signal back to the data reader through wireless communication system. Finally, a door control system connected to the data reader is activated according to the signal transmitted by the controlling server.

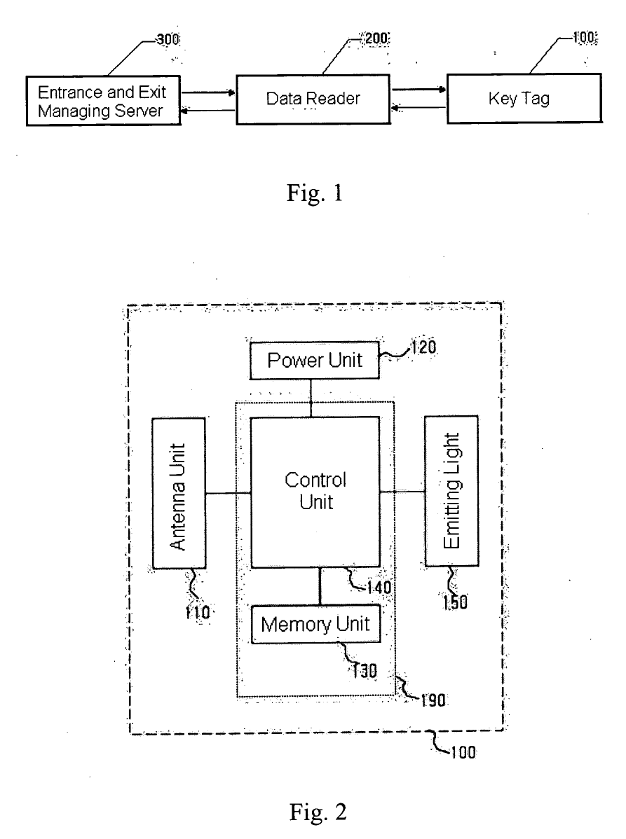

As shown in FIG. 1, an overall block diagram is presented for managing the entrance and exit of employees by utilizing a keytag. The system for managing entrance and exit of employees comprises: a keytag (100) being carried by an employee emits a unique frequency containing personal ID data along with a visible flashing light signal when a keytag bearer approaches or brings it into contact with a terminal scanner at the check point, a data reader (200) for receiving the unique personal ID data signal emitted by the keytag (100), and a controlling server (300) for comparing the received personal ID data with the pre-stored personal ID data in the database to determine a permission.

Each keytag (100) has a memory chip to store a unique frequency corresponding to the bearer's personal ID data which is impossible to duplicate. The keytag (100) uses HF or UHF for transmitting over a long range without scanning. The keytag (100) also has a hook and loop for carrying to hang on the individual's neck.

The keytag (100) is composed of a memory chip (130) for storing the bearer's personal ID data, an antenna unit (110) for transmitting the bearer's personal ID data to the reader by means of scanning or remote communications, a power source (120) for activating the keytag (100), a signal light unit (150) for emitting the visible signal of the personal ID data, and a control unit (140) for controlling each component of the inter-connected units.

On the other hand, the data reader (200) receives a signal containing the personal ID data emitted by the keytag (100), and transmits the signal to a control server (300). The data reader (200) is usually installed at the entrance to a building to read the personal ID data from the user's keytag (100). The unique frequency of the personal ID data and time information, such as an arrival or leaving time are recorded in the control server (300).

Then, the controlling server (300) compares the received personal ID data with the pre-stored personal ID data in the database of the controlling algorithm. If the input data verifies employment, the controlling server (300) transmits a signal of access permission to the door operation mechanism. At the same time, the controlling server (300) records the personal entering and leaving status.

As shown in FIG. 2, an internal configuration of the keytag (100) for managing the entrance and exit of employees is presented. The keytag (100) is equipped with a memory chip to store a unique copy-protected personal ID data. The keytag is provided with an operable latch with a loop for carrying by each employee.

The keytag (100) consists of a memory chip (130) for storing the bearer's personal ID data, an antenna unit (110) for transmitting the bearer's personal ID data to the reader by means of scanning or remote communications, a power source (120) for activating the keytag (100), a signal light unit (150) for emitting the visible signal of the personal ID data, and a control unit (140) for controlling each component of the inter-connected units.

The antenna unit (110) transmits the personal ID data signal stored in the keytag (100) to the data reader installed at the entrance by means of direct scanning or remote communications. It also is provided with functions to check whether the signal is read correctly, standby or misread.

Inside of the keytag (100), a compact disk- or coin-shaped battery is installed as a power source (120) to light a diode bulb. When a keytag bearer approaches the entrance terminal, the keytag (100) is influenced by the emitted frequency of the data reader. Then, the keytag (100) induces the induction voltage to emit the same frequency of the personal data. At the same time, the keytag (100) lights the Diode to emit a flashing visible light. Furthermore, the power source (120) provided inside the keytag (100) can be either one of an induction battery type, a mercury battery type or a disposable battery type of 6 to 12 months life span.

The control unit (140) controls each component of the keytag (100) for emitting the personal ID data in the memory chip (130) through the antenna unit (110).

The memory unit (130) storing each personal ID data adopts a chip-on board (COB) construction consisting of an IC chip. The COB is assembled with the circuits and IC chips on the substrate. The COB containing the chips for bell sound and flashing light diode with connecting wires is molded by dipping it into an adhesive for protection.

The signal light unit (150) consists of either a plurality of Light Emitting Diodes (LED) or the fiber optic lenses connected to an LED. Due to occurrence of the induced voltage, the signal light unit (150) using the same frequency as the data reader emits a flashing light when it approaches within a certain range of the data reader. At this point, the signal light unit (150) is powered to turn on the transistor for emitting the visible flashing Diode light. A signal light unit (150), antenna unit (110), memory chip (130), power source (120) and control unit (140) are installed within a compact disc-shaped case of the keytag (100).

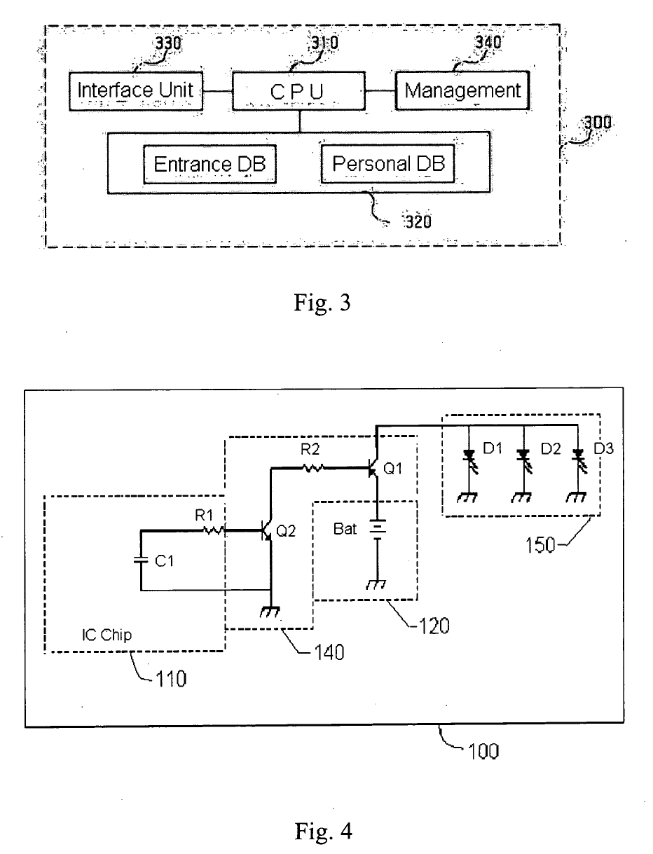

As shown in FIG. 3, an internal configuration of the controlling server (300) for managing the entrance and exit of employees is presented.

The controlling server (300) communicates the personal data with the data reader (200) located at the entrance terminal for controlling the arrival or leaving status of the employees. The controlling server (300) consists of a central processing unit (310), data storage unit (320), external interface (330), management unit (340) and LCD displayer.

The central processing unit (310) must have enough capacity to process the large amount of business tasks, exchanging information, carrying out the calculation and searching the data stored in the database. The CPU used can be any one of the Intel 100 MHz P54C, Motorola 120 MHz Power PC604, or Sun Microsystems 166 MHz Ultra SPARC-1 series along with the separate operating system.

The external interface (330) is used for communicating the personal ID data with the data reader (200) located at the entrance terminal.

The data storage unit (320) consists of a unit for recording the entrance data base (DB) and personal data base (DB). This unit can use database software, for example, a database software manufactured by Oracle Co. The data storage unit (320) is pre-loaded with the employee's personal ID data. When the data reader (200) transmits the signals, the data storage unit (320) records the employee's arriving time, leaving time, social security number and employee serial number.

As shown in FIG. 4, a circuit diagram of the keytag is presented for emitting the signal light. The keytag (100) comprises an antenna unit (110) for transmitting the employee's individual ID data to the data reader by either direct contact or remote transmitting, a power unit (120) for activating the keytag (100), a memory unit (130) for storing the bearer's personal ID data, a signal light unit (150) for emitting the visible signal, and a control unit (140) for controlling each component of the inter-connected units.

As seen in the keytag circuit diagram, the antenna unit (110) is connected to the IC chip in the chip-on board (COB) structure. Because both data reader and keytag use the same frequencies, the induced voltage is generated in the keytag to emit the flashing light signal when it approaches within a certain range of the data reader. Then, the induced voltage is transmitted to turn on a NPN transistor Q2, and a PNP transistor Q1. Sequentially, the power is supplied to the Light Emitting Diode (LED) for activating the signal light (150).

When the keytag is located within the range of the data reader, the antenna unit (110) detects the same frequency as the data reader. Then, the memory unit (130) transmits a signal of the bearer's personal ID data.

Through the above process, the signal light (150) is energized by the power source (120) for emitting the visible flashing light. The signal light unit (150) can consist of various colored LEDs with letter or picture indicator.

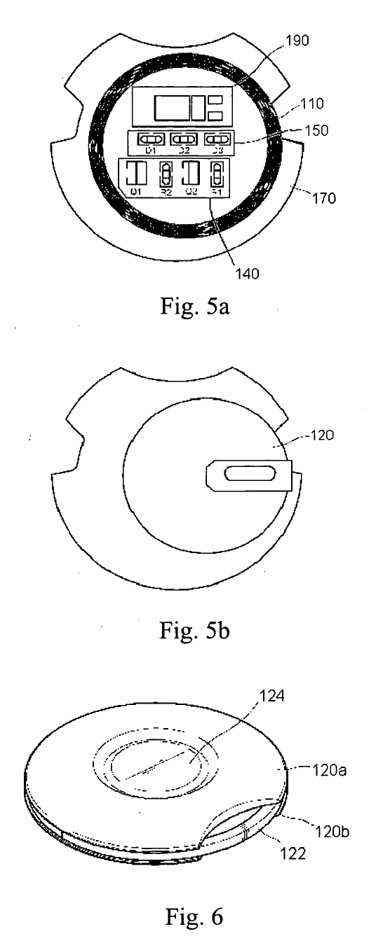

As shown in FIGS. 5a and 5b, an internal front and rear view of the keytag for emitting the signal light are presented.

The keytag (100) is designed to be carried by each employee and is equipped with a memory chip to store a unique copy-protected personal ID data.

The front portion of the keytag (100) forms a circuit substrate (170) to install a signal light unit (150), an antenna unit (110) for transmitting the personal ID data to the data reader, a memory chip (130) for storing the personal ID data, and a control unit (140) in the form of a COB chip (190) for controlling all units. The circuit substrate (170) forms a disc shape with a cutout in one corner for a latch.

The rear of the keytag (100) is designed to accept a power source (120).

As shown in FIG. 6, a schematic drawing of the keytag used for managing the entrance and exit of employees is presented.

The keytag (100) comprises an upper cover (120a), a lower base (120b), a hook (122) and a transparent portion (124) for emitting the flashing light. The upper cover (120a) is designed to couple and un-couple with the lower base (120b). The hook (122) is latchable to carry around the bearer's neck.

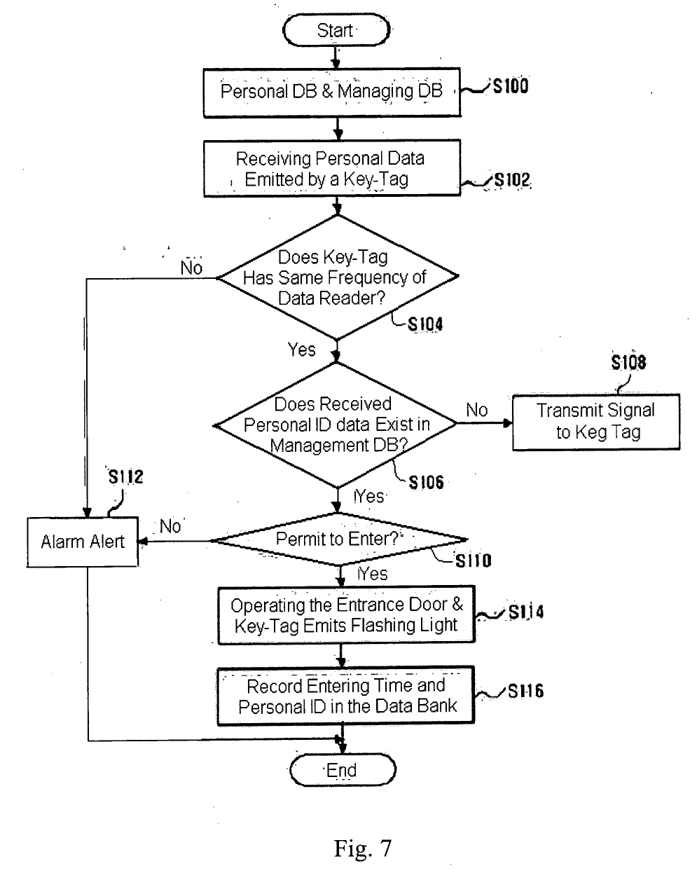

As shown in FIG. 7, a flow chart for managing the entrance and exit of employee by utilizing an electronic keytag is presented.

When a keytag bearer approaches the entrance terminal, a data reader at the entrance receives the personal ID data emitted by the keytag. The data reader transmits the received personal ID data to a controlling server for searching the pre-stored personal ID in the data base. After completing the search, the controlling server determines the access permission through the programmed algorithm. If employment is verified, a door control system connected to the data reader is activated to permit entrance. If not, an alarm is alerted.

A method for managing the entrance and exit of employees through a gate by utilizing a keytag comprises the steps of:

First, the personal ID data, for example the employee's name, social security number, serial number, division or department, address, telephone number, etc. are pre-stored in the personal data base (DB) and entrance management data base (DB) of the controlling server (S100).

Then, a personal ID data signal emitted by a keytag is received when a key bearer approaches or brings the keytag into contact on an entrance terminal scanner to pass the check point (S102).

Check whether the received signal emitted by the keytag is the same frequency as the entrance terminal scanner (S104).

If the frequency of the data reader matches that of the keytag, an induced voltage is generated in the keytag. The induced voltage is sequentially activated to turn on a transistor Q1 and Q2 for emitting a flashing light signal.

When the signal is transmitted, the controlling server searches whether the received personal ID exists in the pre-stored personal ID data base (S106).

If the received personal ID data is not valid, the denial signal is transmitted to the door controller (S108). At the same time, an alarm signal is alerted (S112).

If the received personal ID data is valid, the keytag bearer is verified with the received personal ID data and the pre-stored personal ID data (S110),

If the bearer is verified with the received personal ID data, a permission signal is transmitted to allow the bearer to pass through the entrance (S114).

At the same time, the permission indicating light is lit at the gate and the flashing light is lit on the bearer's keytag.

Then, the entering time and current status of the personal ID are recorded in the employee management data base (S116).

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

As discussed so far, the keytag technology of the present invention has to the advantage of effectively managing the entrance and exit of employees. It also has the merit of effectively operating with the same frequency (as what?) and generating a visible flashing signal light when the keytag bearer approaches within the range of the data reader.

What is claimed is:

1. A system for managing the entrance and exit of employees through a check point by utilizing an electronic device; the system is composed of:
a keytag (100) for emitting a unique frequency containing personal ID data along with a flashing light signal when said keytag bearer arrives at or brings it into contact with an entrance terminal scanner to pass the check point,
a data reader (200) for receiving said unique personal ID data emitted by said keytag (100),
a controlling server (300) for comparing said received unique personal ID data with a pre-stored personal ID data base to determine an access permission.

2. A system for managing entrance and exit of employees as claimed in claim 1, said keytag (100) further comprising a memory unit (130) for storing the personal ID data, an antenna unit (110) for communicating the personal ID data signal by remote or through contact, a power source (120) for activating the keytag (100), a signal light unit (150), and a control unit (140) for controlling each component of the inter-connected units.

3. A system for managing entrance and exit of employees as claimed in claim 2, said signal light unit (150) further comprising a plurality of Light Emitting Diodes (LEDs).

4. A system for managing entrance and exit of employees as claimed in claim 2, said power source (120) further comprising either a compact inductive battery, a mercury battery, or a disposable battery.

5. A system for managing entrance and exit of employees as claimed in claim 1, said keytag (100) further comprising a latchable hook (122) for attaching to a looped chain.

6. A method for managing entrance and exit of employees through a check point by utilizing an electronic device; the method comprises the steps of:
receiving a signal of personal ID data emitted by a keytag when a key bearer arrives or brings the keytag into contact on an entrance terminal scanner to pass the check point, (S100),
checking whether a frequency of the received signal emitted by the keytag matches that of the entrance terminal scanner (S104),
searching whether the received personal ID data is in the pre-stored personal ID database of a controlling server (S106),
identifying the key bearer with the received personal ID data, if the received personal ID data is found in the pre-stored personal ID data base (S110),
permitting the bearer to pass through the check point, if the bearer is identified with the received personal ID data (S114), and
recording the time of the interaction and the personal ID data (S116).
